(19) United States
(12) Patent Application Publication
(10) Pub. No.: US 2024/0404250 A1
(43) Pub. Date: Dec. 5, 2024

(54) METHOD AND SYSTEM FOR INVENTORYING AND DEVELOPING THE VALUE OF REAL PROPERTY

(71) Applicant: David M. Barnett, Ballston Spa, NY (US)

(72) Inventor: David M. Barnett, Ballston Spa, NY (US)

(21) Appl. No.: 18/800,234

(22) Filed: Aug. 12, 2024

Related U.S. Application Data
(63) Continuation-in-part of application No. 17/980,609, filed on Apr. 11, 2022, now Pat. No. 12,062,071.
(60) Provisional application No. 63/275,539, filed on Nov. 4, 2021.

(51) Int. Cl. G06V 10/77; G06Q 30/02; G06Q 50/16; G06V 20/10

(52) U.S. Cl. CPC G06V 10/7715; G06Q 30/0278; G06Q 50/16; G06V 20/176; G06V 2201/10

(57) ABSTRACT

A method and system of inventorying and developing value for real property. An image or an aerial photograph of a property to be inventoried and valued is obtained, an outline or outlines of the structure and its location on the property are identified, outlines of the structural sections of the property are mapped, a partial sketch of the outline of the structure is created, wherein the outline includes square footage estimates for each section, and is oriented with the front of the structure to the bottom of the page, and the information is integrated across multiple images and the structural type of each section of the structure is identified. The method and system rely on machine learning in order to increase the accuracy of the method and system.

### CROSS-REFERENCE TO RELATED APPLICATIONS

This application claims priority to U.S. Non Provisional Application having Ser. No. 17/980,609, filed on Nov. 4, 2022, and U.S. Provisional Application having Ser. No. 63/275,539, filed on Nov. 4, 2021, the entire disclosure of which is hereby incorporated herein by reference.

### FIELD OF INVENTION

This invention is directed to a method and system of inventorying and developing value of real property. In particular, the method and system are highly accurate in inventorying and developing the value of real property.

### BACKGROUND OF INVENTION

Historically, inventorying a property required an individual data collector to perform a site visit on each property in order to verify data about that property. The data collector would go to each individual property door to door and ask questions and collect data for purposes of inventorying the property. From there, the data collector would walk around the property and inventory what is on the property. For example, the data collector would inventory garages, decks, pools, and similar amenities. As can be imagined, this process is time-consuming and inefficient.

For a real property valuation services appraisal business charged with inventorying and developing values for large numbers of properties to support municipal tax reassessments for towns, cities, jurisdictions, and counties, the process for municipal contracts is very manual and tedious. Data collectors inspect aerial and street-level images of thousands of properties in order to break down properties into structurally distinct segments, determine the square footage of each segment, identify the structural type (garage, covered porch, two-story no basement, etc.), and record all of this information in the form of a footprint or a sketch or sketches of the property.

Because this process is very time-consuming and resource-intensive, it would be beneficial if part or all of the process could be automated.

### SUMMARY OF THE INVENTION

Accordingly, it is the subject of this invention to provide a method and system for automating the process of municipal assessment projects so as to reduce the required time, effort, and cost.

In one embodiment, the present method relies on aerial imagery taken during flyovers. It is envisaged that the aerial imagery is taken by a drone camera or another aerial photography method. Using the aerial imagery, a structure sketch is drawn using a program that allows the user to click, draw a line, and/or define areas indicating the square footage of the property.

In another embodiment, the sketch results from extracting data from property record cards. A property record card is a document maintained by a local government, typically a jurisdiction, county, or municipal assessor's office, that contains detailed information about a specific piece of real estate. The property card usually includes pertinent property characteristics such as land area (size of the lot), description of any buildings or structures (e.g., square footage, number of stories, construction type) and, number and size of rooms. In some cases, the property record card includes an image of the property. Similar to the method using an aerial photograph, after scanning a property record card, a structure sketch is drawn using a program that allows the user to validate the defined areas indicating the square footage of the property.

The sketch may then be taken to the physical property to discern that the area and property depicted in the structure sketch is accurate. The overall depiction of the property is arrived at by utilizing and synthesizing aerial and satellite imagery with street level imagery and other resources. The resultant imagery is used to train a model to be able to perform this process on a property that hasn't been visited via an on-site inspection.

Overall, this process and system is capable of creating highly accurate sketches that can be used for inventorying and developing the value of the property.

### BRIEF DESCRIPTION OF THE DRAWINGS

FIG. 1 depicts a flow chart of the present invention.

### DETAILED DESCRIPTION OF THE INVENTION

One embodiment of the present invention provides computer vision-based software that is capable of integrating information across multiple platforms and resources such as images, past sketches, and structured data sources. The software is also capable of automatically generating sketches for the majority of properties and flagging properties that require manual review or physical site visits from data collectors. In particular, the present invention relies on machine learning.

In one embodiment of the present invention, the method relies on overhead or aerial photos. Alternatively, the method may rely on information from scanned property record cards. The outline of the structure is identified on the property either from the overhead image or the property record outline

From there the outlines of structural sections of the structure are mapped from the aerial image or property record card. The square footage of each section is computed. A partial sketch of the structure with each distinct sections specified is generated. Information across multiple images and ID structural type of each section is integrated.

A labeling process allows a machine learning model to identify buildings. In this embodiment, machine learning results from overlaying sketch outlines on top of property images.

The software is trained by identifying structures within images, orienting to the front based on roads or driveways, and tracing the outline of structures and sections, then computing the square footage by section.

In one embodiment, aerial imagery from drones or other method is used by a program that allows a user to draw a line indicating the footage of the property.

In an alternate embodiment, property record cards are used to provide enough information to draw an outline or sketch using the above program. It is noted that the property record cards provide house images that are an alternative to aerial images. In particular the program is able to use the sketch that is in the property record card. The outline or sketch is taken to the physical property to check for accuracy.

The overall depiction of the property is arrived at by utilizing and synthesizing aerial and satellite imagery with street level imagery. The resultant imagery is used to train a model to be able to perform this process on a house that hasn't been visited via an on-site inspection. Overall, this process and system is capable of creating highly accurate building plans and drawings.

In one embodiment, the model processes aerial imagery from an API. Alternatively, the model processes property records cards from an API. These cloud-hosted images provide two datasets used for training the model. The aerial images provide one dataset, while the property record cards provide another. There is a function that clips property boundaries within images from GIS and aerial image. A mask for the buildings is generated. The first phase is to annotate the original images.

The present invention comprises the steps of:
obtaining multiple photographs of a property to be inventoried taken from a near-vertical overhead perspective;
alternatively, scanning property record cards of a property to be inventoried;
identifying the outline of the house or structure on the property and location of the front of the house or structure within the image or property record card;
mapping outlines of structural sections of the house or structure from the image or property record card and computing square footage of each segment;
returning a partial sketch of the outline of the house or structure with distinct structural sections specified, square footage estimates for each section, and oriented with the front of the house or structure to the bottom of the page; and
integrating information across multiple images and identifying the structural type of each section of the house or structure utilizing trained or preexisting models.

The present invention relies on machine learning. Selected samples of imagery and sketches from verified dates are used to train the software. Coordinates, imagery, sketches, and property data are input into the model allowing the model to learn the accuracy of the imagery. The software may or may not require access to a graphics processing unit (GPU).

In one embodiment, machine learning results from overlaying sketch outlines on top of property images. First, the software is trained by identifying homes or structures within images, identifying the front of homes or structures based on structural properties and/or orientation of the home or structure relative to road, driveway, etc., and tracing the outline of a home or a structure and its sections, and computing square footage by section.

In one embodiment, the present method relies on aerial imagery taken during flyovers by a drone camera or another aerial photography method. Using the aerial imagery, an outline or sketch is drawn using a program that allows the user to click and draw a line indicating the footage of the property.

In an alternative embodiment, the present method relies on property record cards to provide enough information to draw an outline or sketch using the above program.

The outline or sketch is then taken to the physical property to discern that the area and property depicted in the sketch is accurate. The overall depiction of the property is arrived at by utilizing and synthesizing aerial and satellite imagery with street level imagery. The resultant imagery is used to train a model to be able to perform this process on a house that hasn't been visited via an on-site inspection.

Overall, this process and system is capable of creating highly accurate building plans and drawings that can be used for inventorying and developing the value of the real property.

In one embodiment, the model includes automated code for extracting, clipping, and processing aerial imagery from an API. The system can be divided into two topics, GIS and computer vision. Alternatively, the model model includes automated code for extracting, clipping, and processing property record cards from an API.

A customized querying of an API and automated acquisition and storing of images in a cloud-based processor for the machine learning dataset.

The API provides the following to the user:
Automated authorization;
Facilitates data acquisition, single or multiple addresses;
Allows a user to tailor the data format wanted;
Allows a user to store data both to a cloud-based process bucket or local storage; and,

As part of querying a gateway or as an independent method that can be used on an image and its metadata file, a Georeferencing Image Function was developed which references geographically a given image on the earth's surface (for example, in New York State), and the clipping Image function which references the given's house address' parcel and clips the image based on its boundaries as provided by the municipality.

The format used to annotate the masks of the buildings for the training set is the COCO format.

The first phase is to annotate the original images and create the labels by manual image tagging. All the data is stored including annotated and not annotated in a database as a css file and this data guides the training phase.

In the database or data folder are batches that have been created and consists of original images that will be annotated. From the address_points.csv we checked the condition of each batch.

### Computer Vision Model

A U-Net 2 model was developed, which is a convolutional network architecture for fast and precise image segmentation.

The model's code can be found in the database or processor or on a machine learning platform such as Amazon's Sagemaker®.

In a database there is an abstract class that represents the dataset and there is a dataloader which is an iterator that is being used to batch, shuffle and load the data utilizing the dataset class.

### Results

Two metrics to evaluate and monitor the model's training process were used. A combination of the Binary Cross Entropy (BCE) loss and the Dice Loss which allows for some diversity and stability in the loss through the training. Another indicator for the model's accuracy are the range errors, which are extracted by the intersection of the pixels that belong to the edges of the mask and the original images.

### EXAMPLE

### Example 1

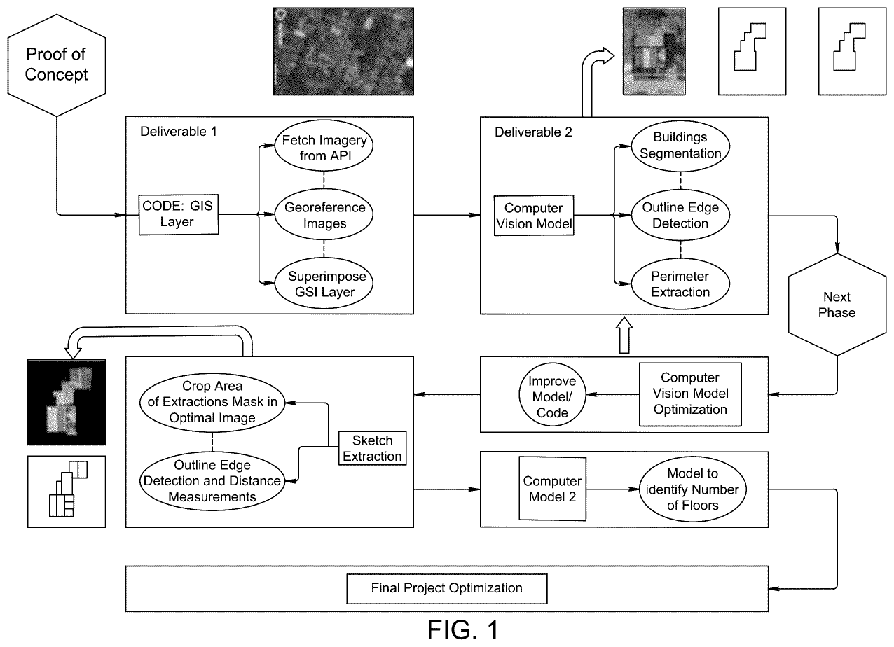

Example 1 is depicted in FIG. 1. As can be seen, in the first step, Deliverable 1 is produced. This involves a geographic information system (GIS) LAYER Code that fetches imagery from a specific application programing interface (API), obtains georeference images, and superimposes a GIS layer on the imagery. The georeference images are provided by municipalities and include all of the information about the parcel including all of the boundaries. The georeference images may be stored in a database. The imagery is provided by drone photography or another method of acquiring aerial photographs so that it is taken directly above a parcel, building, or structure.

Deliverable 2 is provided by developing a computer vision model that outlines the edges of a building or structure and also outlines the perimeter of the building or structure. The computer vision model is run by logic. The computer vision model is also capable of providing building segmentation. That is, computer vision model includes data on what different rooms in a building look like based on size, location within the building, and other features.

From there, the Next Phase provides optimization and improvement of the model. The system may go back to the Deliverable 2 step if further improvements of the building or structure inventory is needed or the system may move onto the next step of Sketch Extraction, which involves either cropping the area of the extracted mask (of the perimeter of the building or structure) in the original image and/or outlining or edge detection and distance measurements of the extracted mask. Next, the system develops a second computer vision model, which identifies the number of floors of the building or structure. Finally, the system is optimized and the final product for the project is provided.

The GIS layer is provided by jurisdictions, counties, and municipalities and includes the parcel boundaries. All of the layers and data are uploaded into and stored in a database. The API then loads the aerial imagery of a dwelling. The superimposed layer is processed in a cloud-based processor such as Amazon Web Services® (hereinafter “AWS”) or Microsoft Azure®. It is noted that any cloud-based processor may be used.

The GIS layer allows the system to georeference the layer. When a parcel layer is overlayed onto an aerial image, then the parcel information is used to georeference the parcel in the aerial image. That is, to locate where the parcel is.

In particular, the GIS layer is superimposed and overlaid onto the aerial image so that the parcel boundaries are known. Additionally, the GIS layer information will help create a scale for the measurements of the house. If the dimensions of the parcel from the GIS layer are known, then you know the scale for the measurements of the house.

The vision model uses data or information to identify segments of a dwelling based on the shape. For example, it will help identify the bathroom, living room, and other rooms of a house.

### Example 2

Example 2 includes the following steps:
parcel or SBL is selected by a user and input into a parcel API;
location parameters are fetched from AWS S3 stored shameful data;
ortho imagery is fetched from imagery API;
metadata including parcel perimeter and boundaries is extracted and stored on AWS S3;
a model on AWS EC2 instance predicts a mask of the parcel;
GIS code or GIS logic on AWS EC2 instance provides a georeference of the parcel and clips the parcel mask;
python code or python logic on AWS EC2 instance extracts area data;
data is stored on S3 AWS; and,
data is sent or exposed to parcel API as a downloadable file.

### Example 3

Example 3 is nearly identical to Example 1 with the main difference being that the source of the imagery is from a property record card, rather than an aerial image. Property record cards are scanned using AI and OCR methods. Vision modeling allows the capture of a sketch on the property record card. From there, the sketch is pulled into a sketch model and validated.

### Example 4

In example 4, the method includes the steps of fetch geographic information set property data and fetching aerial images, combining the two, using a vision model that has been trained to understand building perimeters and sections, using a “sketch extraction module” to take the segmentation, boundary, and perimeters, creating a sketch, and using a second vision model to determine floor layers.

It will be appreciated by those skilled in the art that while the method for inventorying and developing the value for real property has been described in detail herein, the invention is not necessarily so limited and other examples, embodiments, uses, modifications, and departures from the embodiments, examples, uses, and modifications may be made without departing from the process and all such embodiments are intended to be within the scope and spirit of the appended claims.

What is claimed is:

1. A computer-generated method comprising:
receiving, by a server or a processor, geographic information system layer input that includes parcel data;
responsive to receiving the parcel data, the server or the processor initiates fetch logic to request aerial imagery from an imagery API;
responsive to receiving the aerial imagery, the server or the processor overlays the geographic information system layer onto the aerial imagery generating a superimposed layer;
receiving, by a computer vision model from the server or processor, the superimposed layer and a building dataset;
responsive to receiving the superimposed layer and the building dataset, the computer vision model initiates a vision logic, which generates a segmentation layer, a boundary layer, and a perimeter layer;
receiving, by the server or the processor, the segmentation layer, the boundary layer, and the perimeter layer,
receiving, by a sketch extraction model, the segmentation layer, the boundary layer, and the perimeter layer;
responsive to receiving a segmentation layer, a boundary layer, and a perimeter layer, the sketch extraction model uses sketch logic to generate a sketch layer;
receiving, by the server or the processor, the sketch layer;
receiving, by a second computer vision model, the sketch layer;
responsive to receiving the sketch layer, second computer vision model initiates a second vision logic, which generates a floor layer;
receiving, by a server or processor, the floor layer; and,
responsive to receiving the floor layer, the server or the processor initials optimizing logic, which generates an optimized layer.

2. The computer-generated method of claim 1, wherein the parcel data is provided by a municipality.

3. The computer-generated method of claim 1, wherein the computer vision model is a machine learning platform.

4. The computer-generated method of claim 3, wherein the step of responsive to receiving the superimposed layer and building dataset, the computer vision model initiates a vision logic, which generates a segmentation layer, a boundary layer, and a perimeter layer may be iterative and may be performed at least two times.

5. A computer-generated method comprising:
receiving, by a server or a processor, geographic information system layer input that includes parcel data;
responsive to receiving the parcel data, the server or the processor initiates fetch logic to request imagery from a property record card from an imagery API;
responsive to receiving the imagery, the the server or the processor overlays the geographic information system layer onto the aerial imagery generating a superimposed layer;
receiving, by a computer vision model from the server or the processor, the superimposed layer and a building dataset;
responsive to receiving the superimposed layer and the building dataset, the computer vision model initiates a vision logic, which generates a segmentation layer, a boundary layer, and a perimeter layer;
receiving, by the server or the processor, the segmentation layer, the boundary layer, and the perimeter layer,
receiving, by a sketch extraction model, the segmentation layer, the boundary layer, and the perimeter layer;
responsive to receiving the segmentation layer, the boundary layer, and the perimeter layer, sketch extraction model uses sketch logic to generate a sketch layer;
receiving, by the server or the processor, the sketch layer;
receiving, by a second computer vision model, the sketch layer;
responsive to receiving the sketch layer, the second computer vision model initiates a second vision logic, which generates a floor layer;
receiving, by the server or the processor, the floor layer; and,
responsive to receiving the floor layer, the server or the processor initials optimizing logic, which generates an optimized layer.

6. The computer-generated method of claim 5, wherein the parcel data is provided by a municipality.

7. The computer-generated method of claim 5, wherein the computer vision model is a machine learning platform.

8. The computer-generated method of claim 7, wherein the step of responsive to receiving the superimposed layer and the building dataset, the computer vision model initiates a vision logic, which generates a segmentation layer, a boundary layer, and a perimeter layer may be iterative and may be performed at least two times.

9. A computer-generated method comprising:
receiving, by a server or a processor, geographic information system layer input that includes parcel data;
responsive to receiving the parcel data, the server or the processor initiates fetch logic to request imagery from an imagery API;
responsive to receiving the imagery, the the server or the processor overlays the geographic information system layer onto the aerial imagery generating a superimposed layer;
receiving, by a computer vision model from the server or the processor, the superimposed layer and a building dataset;
responsive to receiving the superimposed layer and the building dataset, the computer vision model initiates a vision logic, which generates a segmentation layer, a boundary layer, and a perimeter layer;
receiving, by the server or the processor, the segmentation layer, the boundary layer, and the perimeter layer,
receiving, by a sketch extraction model, the segmentation layer, the boundary layer, and the perimeter layer;
responsive to receiving the segmentation layer, the boundary layer, and the perimeter layer, sketch extraction model uses sketch logic to generate a sketch layer; and,
receiving, by the server or the processor, the sketch layer.

10. The computer-generated method of claim 9, wherein the parcel data is provided by a municipality.

11. The computer-generated method of claim 9, wherein the computer vision model is a machine learning platform.

12. The computer-generated method of claim 11, wherein the step of responsive to receiving the superimposed layer and the building dataset, the computer vision model initiates a vision logic, which generates a segmentation layer, a boundary layer, and a perimeter layer may be iterative and may be performed at least two times.
